(19) United States
(12) Patent Application Publication
(10) Pub. No.: US 2026/0239329 A1
(43) Pub. Date: Aug. 13, 2026

(54) DEVICES AND METHODS FOR TRANSMISSION FOR CONFIGURED GRANT

(71) Applicant: Lenovo (Beijing) Limited, Beijing (CN)

(72) Inventors: Ruixiang Ma, Beijing (CN); Haipeng Lei, Beijing (CN)

(73) Assignee: Lenovo (Beijing) Limited, Beijing (CN)

(21) Appl. No.: 19/473,352

(22) PCT Filed: Apr. 7, 2023
(86) PCT No.: PCT/CN2023/087014

§ 371 Date: Oct. 7, 2025

(51) Int. Cl. H04W 72/115; H04B 7/06

(52) U.S. Cl. CPC H04W 72/115; H04B 7/0626

(57) ABSTRACT

Embodiments of the present disclosure relate to devices, methods, and a non-transitory computer readable medium for transmission occasions in configured grant (CG) period. A terminal device determines indication information, wherein the indication information indicates a usage status of at least one transmission occasion (TO) or group of TOs among multiple TOs indicated by a configured grant configuration. The terminal device transmit, via the transceiver, the indication information to a network device. In this way, multiple different TBs can be transmitted over the configured multiple TOs.

### FIELD

Embodiments of the present disclosure generally relate to the field of communication, and to devices, methods, and a non-transitory computer readable medium for transmission for configured grant (CG).

### BACKGROUND

New Radio (NR), which is also called as the 5th generation (5G) mobile network, is a new global wireless standard after 1G, 2G, 3G, and 4G networks. The NR enables a new kind of network that is designed to connect virtually everyone and everything together including machines, objects, and devices. NR wireless technology is meant to deliver higher multi-Gbps peak data speeds, ultra-low latency, more reliability, massive network capacity, increased availability, and a more uniform user experience to more users. Higher performance and improved efficiency empower new user experiences and connects new industries.

Xtended Reality (XR) is a broad term covering Augmented Reality (AR), Mixed Reality (MR), Virtual Reality (VR), etc. Along with Cloud Computing, XR applications typically require high throughput and low latency, and have a big packet size and variable data packet size. To realize the low latency requirement and the big packet size, it has been decided in the Third Generation Partnership Project (3GPP) to configure a terminal device such as User Equipment (UE) with multiple Configured Grant CG (CG) occasions (TOs) for Physical Uplink Shared Channel (PUSCH) transmission in a period of a single CG PUSCH configuration. Then the packet could be transmitted in all or parts of configured TOs immediately if it arrives at UE. Considering the network device, such as 5G base station (gNB) does not know the real size of a×R packet and how many TOs would be used by the UE, the number of TOs occupied by the UE may be smaller than the configured number of TOs, which means there would be some TOs would be wasted. Therefore, Further enhancement on transmission for CG is required.

### SUMMARY

In general, example embodiments of the present disclosure provide devices, methods and a computer readable medium for transmission occasions in configured grant (CG) period.

In a first aspect, there is provided a terminal device. The terminal device comprises a processor and a transceiver coupled to the processor. The processor is configured to determine indication information, wherein the indication information indicates a usage status of at least one transmission occasion (TO) or group of TOs among multiple TOs indicated by a configured grant configuration; and transmit, via the transceiver, the indication information to a network device.

In a second aspect, there is provided a network device. The network device comprises a processor and a transceiver coupled to the processor. The processor is configured to receive, via the transceiver, indication information from a terminal device, wherein the indication information indicates a usage status of at least one transmission occasion (TO) or group of TOs among multiple TOs indicated by a configured grant configuration; and determine usage status of the at least one TO or group of TOs among the multiple TOs based on the indication information.

In a third aspect, there is provided a method performed by a terminal device. The method comprises determining indication information, wherein the indication information indicates a usage status of at least one transmission occasion (TO) or group of TOs among multiple TOs indicated by a configured grant configuration; and transmitting, via the transceiver, the indication information to a network device.

In a fourth aspect, there is provided a method performed by a network device. The method comprises receiving indication information from a terminal device, wherein the indication information indicates a usage status of at least one transmission occasion (TO) or group of TOs among multiple TOs indicated by a configured grant configuration; and determining usage status of the at least one TO or group of TOs among the multiple TOs based on the indication information.

In a fifth aspect, there is provided a terminal device. The terminal device comprises means for determining indication information, wherein the indication information indicates a usage status of at least one transmission occasion, TO, or group of TOs among multiple TOs indicated by a configured grant configuration; and means for transmitting, via the transceiver, the indication information to a network device.

In a sixth aspect, there is provided a network device. The network device comprises means for receiving indication information from a terminal device, wherein the indication information indicates a usage status of at least one transmission occasion, TO, or group of TOs among multiple TOs indicated by a configured grant configuration; and means for determining usage status of the at least one TO or group of TOs among the multiple TOs based on the indication information.

In a seventh aspect, there is provided a terminal device comprising: a processor; and a memory storing instructions, the memory and the instructions being configured, with the processor, to cause the terminal device to perform the method according to the third aspect above.

In an eighth aspect, there is provided a network device comprising: a processor; and a memory storing instructions, the memory and the instructions being configured, with the processor, to cause the network device to perform the method according to the fourth aspect above.

In a ninth aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

In a tenth aspect, there is provided a computer program product. The computer program product is encoded with instructions for performing the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates an example network environment in which some embodiments of the present disclosure can be implemented;

FIG. 2A illustrates an example time domain resource allocation for PUSCH with PUSCH repetition Type A related to some embodiments of the present disclosure;

FIG. 2B illustrates an example time domain resource allocation for PUSCH with enhanced PUSCH repetition Type A;

FIG. 2C illustrates an example time domain resource allocation for PUSCH with TBOMS;

FIG. 2D illustrates a simplified block diagram of a UE configured with Type 2 CG that is activated by an activation DCI reporting aperiodic channel state information (A-CSI);

FIG. 2E illustrates a simplified block diagram of TOs from two CG configurations overlapping with each other;

FIG. 3A illustrates an example signaling chart of an example process according to some embodiments of the present disclosure;

FIG. 3B illustrates another example signaling chart of an example process according to some embodiments of the present disclosure;

FIG. 3C illustrates yet another example signaling chart of an example process according to some embodiments of the present disclosure;

FIG. 4A illustrates a simplified block diagram of transmission of multiple TBs according to one embodiment of the present disclosure;

FIG. 4B illustrates a simplified block diagram of transmission of multiple TBs according to another embodiment of the present disclosure;

FIG. 4C illustrates a simplified block diagram of transmission of multiple TBs according to yet another embodiment of the present disclosure;

FIG. 5A illustrates a simplified block diagram of TOs from two CG configurations overlapping with each other according to one embodiment of the present disclosure;

FIG. 5B illustrates a simplified block diagram of TOs from two CG configurations overlapping with each other according to another embodiment of the present disclosure;

FIG. 5C illustrates a simplified block diagram of TOs from two CG configurations overlapping with each other according to yet another embodiment of the present disclosure;

FIG. 5D illustrates a simplified block diagram of TOs from two CG configurations overlapping with each other according to still yet another embodiment of the present disclosure;

FIG. 6 illustrates a flowchart of a method implemented at a terminal device according to some embodiments of the present disclosure;

FIG. 7 illustrates a flowchart of a method implemented at a network device according to some other embodiments of the present disclosure; and

FIG. 8 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

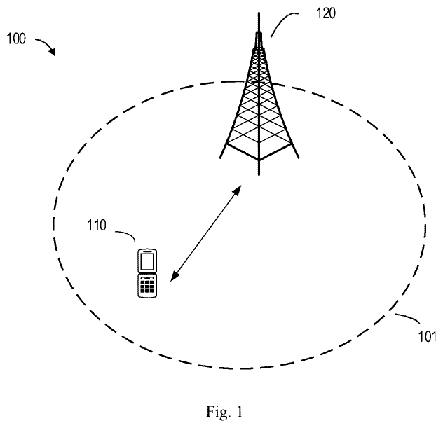

FIG. 1 illustrates an example network environment 100 in which example embodiments of the present disclosure may be implemented. The environment 100, which may be a part of a communication network, comprises terminal devices and network devices.

As illustrated in FIG. 1, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As described hereinbefore, XR applications typically require high throughput and low latency, and have a big packet size and variable data packet size. To realize the low latency requirement and the big packet size, it requires an efficient resource allocation. Currently, PUSCH transmission(s) may be dynamically scheduled by an uplink (UL) grant in a Downlink Control Information (DCI), or the transmissions can utilize resources configured by a configured grant (CG), which may be classified as Type 1 CG and Type 2 CG.

The configured grant Type 1 PUSCH transmission is semi-statically configured to operate upon reception of a higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI after reception of a higher layer parameter configuredGrantConfig not including rrc-ConfiguredUplinkGrant. UE may be configured with one or more CG configurations, and for each CG configuration, a period P and a CG type are provided.

In order to realize the low latency requirement and the big packet size, it has been agreed in the 3GPP to configure multiple CG PUSCH transmission occasions (TOs) in a period of a single CG PUSCH configuration.

There are several mainly schemes for resource allocation in time domain, which including PUSCH repetition Type A introduced in Rel-15, and PUSCH repetition Type B introduced in Rel-16. Enhancements on PUSCH repetition Type A is beneficial for PUSCH coverage enhancements for TDD. In Rel-17, TB processing over multi-slot (TBOMS) is supported that for a certain PUSCH transmission, which scheme among these schemes is used could be configured by higher layer parameter. Only for illustrative purposes, example time domain resource allocations for some of these schemes would be described as follows.

For a CG configuration, a SLIV could be configured for PUSCH repetition Type A, the starting symbol S relative to the start of the slot, and the number of consecutive symbols L counting from the symbol S allocated for the PUSCH are determined from the start and length indicator SLIV of the indexed row:

```
if (L − 1) ≤ 7 then
  SLIV = 14 · (L − 1) + S
else
  SLIV = 14 · (14 − L + 1) + (14 − 1 − S)
where 0 < L ≤ 14 − S .
```

the number of repetitions K may be determined as:
   if numberOfRepetitions is present in the resource allocation table, the number of repetitions K is equal to numberOfRepetitions;
   else if the number of repetitions K is provided by the higher layer configured parameters repK.

For PUSCH repetition Type A, in case K>1, the same symbol allocation is applied across the K consecutive slots. The UE shall repeat the TB across the K consecutive slots applying the same symbol allocation in each slot.

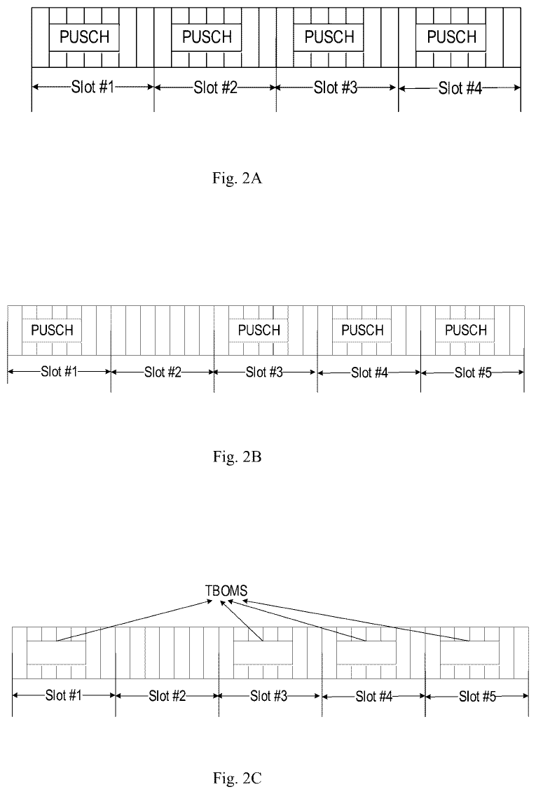

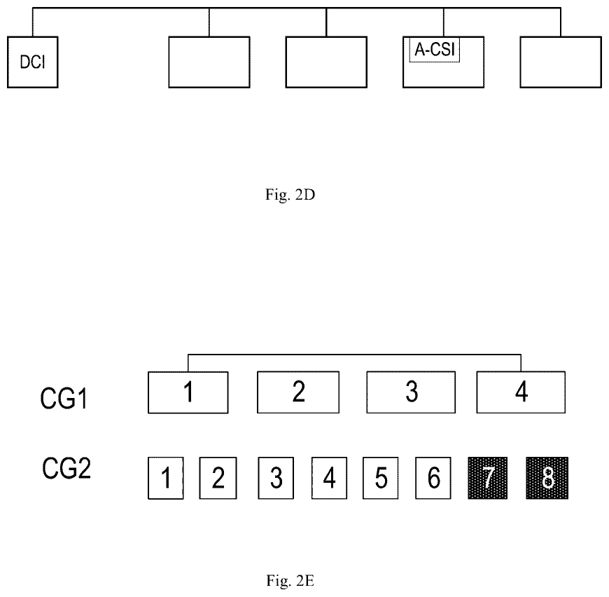

For example, assuming for a CG configuration, the start slot is slot #1, S=2, L=8, K=4, then the example time domain resource for PUSCH with PUSCH repetition Type A may be found in FIG. 2A.

For PUSCH repetition Type A, a PUSCH transmission in a slot of a multi-slot PUSCH transmission is omitted if any symbol of the PUSCH is overlapped with the set of symbols of the slot that are indicated to a UE as downlink by tdd-UL-DL-ConfigurationCommon, or tdd-UL-DL-ConfigurationDedicated.

For enhanced PUSCH repetition Type A, the resource allocation in time domain is almost same as PUSCH repetition type A, excluding that the number of repetitions is counted on the basis of available slots. In particular, a slot may be determined as unavailable if at least one of the symbols indicated by TDRA for a PUSCH in the slot overlaps with the symbol not intended for UL transmissions, and semi-static flexible symbol configured by tdd-UL-DL-ConfigurationCommon, or tdd-UL-DL-ConfigurationDedicated, is considered as available.

For example, for a CG configuration, the start slot is slot #1, S=2, L=8, K=4, then the time domain resource for PUSCH with enhanced PUSCH repetition Type A could be found in FIG. 2B.

For TBOMS, time domain resource determination may be performed via PUSCH repetition Type A like Time Domain Resource Allocation (TDRA). The number of slots N allocated for a TB transmitting of TBOMS or in other words the slot number N used to calculate the TBS is determined by using a row index of a TDRA list, configured via a radio resource control (RRC) message and is counted based on the available slots for UL transmission. The transmission in each slot could be named as one transmission part of the TB in present disclosure. The determination of available slots is as defined in enhanced PUSCH repetition Type A.

For example, for a CG configuration, the start slot is slot #1, S=2, L=8, N=4, then a example time domain resource for PUSCH with TBOMS may be found in FIG. 2C.

However, the gNB does not know the real size of a×R packet and how many TOs would be used by the U occupied number of TOs might be smaller than the configured number TOs. Therefore, Further enhancement on transmission for CG is required to improve the resource usage for CG.

In addition, there is also required a solution for transmitting multiple different TBs over the configured multiple TOs when multiple CG PUSCH transmission occasions (TOs) are configured. Moreover, when the Type 2 CG is activated by an activation DCI, a UE configured with Type 2 CG also needs to report an aperiodic channel state information (A-CSI) report, but the TO for reporting the A-CSI may be an unused TO (as illustrated in FIG. 2D). Thus, a transmission issue of A-CSI report is to be addressed. Furthermore, when multiple CG configurations are configured for UE, the UE also needs to know how to indicate the unused TO when TOs from multiple CG configuration are overlapped with each other in time domain (as illustrated in FIG. 2E).

In view of the above discussions, embodiments of the present disclosure provide an improved solution for transmission for configured grant (CG). In one aspect of the solution of the present disclosure, a terminal device determines indication information, wherein the indication information indicates a usage status of at least one transmission occasion (TO) or group of TOs among multiple TOs indicated by a configured grant configuration. The terminal device transmits the indication information to a network device.

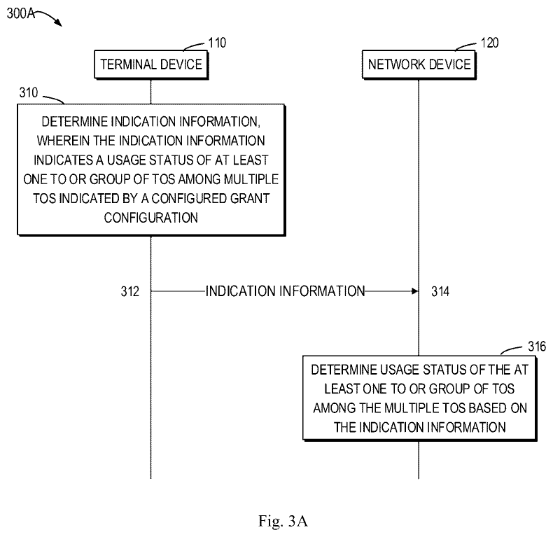

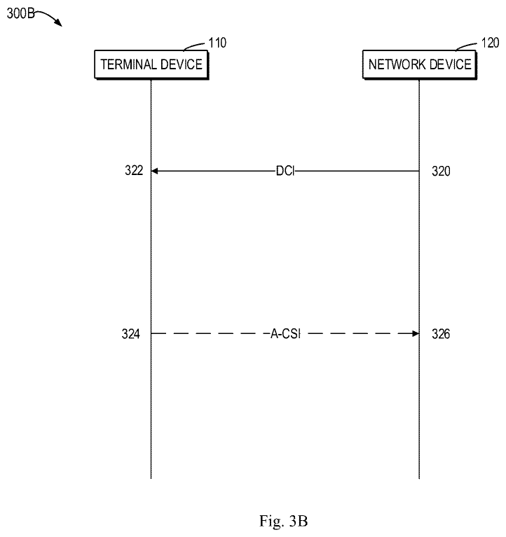

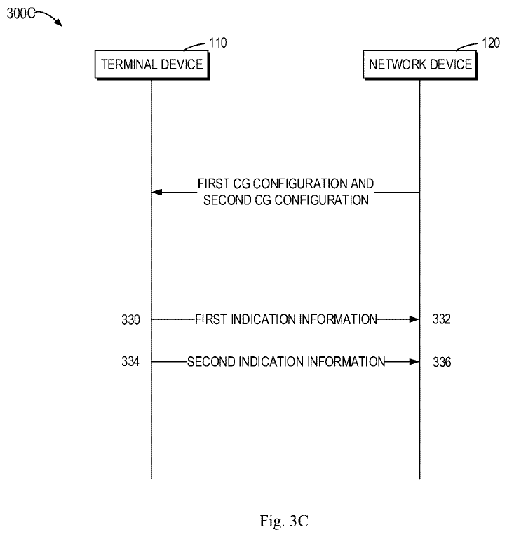

In this way, the resource usage for CG may be efficiently improved by means of the indication information. In addition, further embodiments or another aspects of the present disclosure also provide solutions to address other issues as mentioned before. Hereinafter, principles and implementations of embodiments of the present disclosure will be described in detail with reference to FIGS. 3A-7.

### Example Method

FIG. 3A illustrates an example signaling chart of an example process 200A according to some embodiments of the present disclosure. For the purpose of discussion, the example 200A will be described with reference to FIG. 1.

In the example process 300A, a terminal device 110 determines 310 indication information. The indication information may indicate a usage status of at least one transmission occasion (TO) or group of TOs among multiple TOs indicated by a configured grant configuration. For example, the terminal device 110 may determine indication information based on whether the TO or the group of TOs is to used or not. If the TO or the group of TO is used, then the usage status may indicate it as “used” or not indicated it as unused; otherwise, the usage status may indicate it as unused or not indicate it as used.

In some embodiments, the multiple TOs for a CG configuration may include at least two groups of TOs available for transmitting at least two transmission blocks (TBs).

For example, the UE may determine the multiple TOs in a time duration for a first configured grant (CG) configuration, wherein the time duration could be a periodicity of the first CG configuration. The UE may further determine a parameter M, wherein M represents a number of different TBs could to be transmitted during the time duration. In such a case, the UE may determine usage status for TOs in the at least two groups and transmit the indication information (e.g., a UCI) to indicate the network device that some of the TOs among the multiple TOs are unused. Alternatively, the UE may determine usage status for each of the at least two groups and transmit the indication information (e.g., a UCI) to indicate the network device that some of the TO groups are unused.

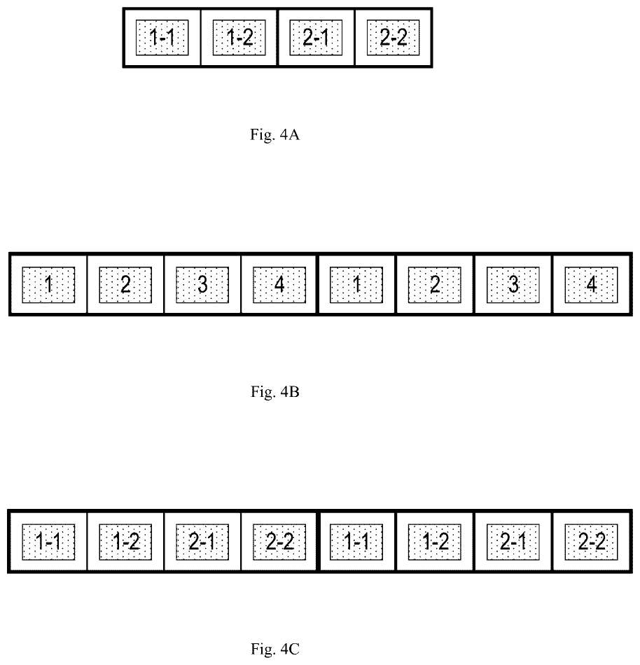

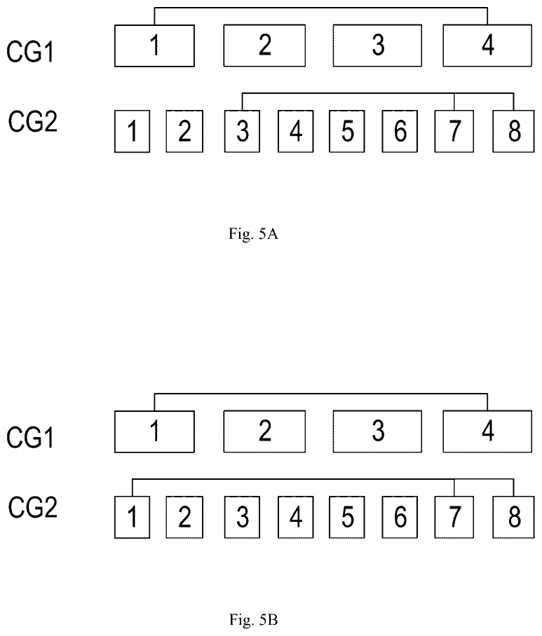

In some embodiments, the multiple TOs may be divided into at least two groups in many different ways. For illustrative purposes, reference will made to FIG. 4A to 4C to describe several options for TO grouping.

Option-1 (Interaction with for Example TBOMS)

In Option 1, all TOs in each of the at least two groups of TOs are configured to transmit a single TB, and the at least two groups of TOs are configured to transmit different TBs. The number of the at least two groups of TOs may be determined based on a number of TBs that can be transmitted in the time duration for the CG configuration.

For example, if a parameter N is configured, wherein N represents the slot number to calculate the transport block size, then UE may determine M groups of TOs could be used to transmit M PUSCH transmissions, and determine the number of TOs in each group as N, wherein the parameter N indicates the number of TOs used to transmit a single TB. In some embodiments, a number of TOs configured to transmit a single TB is determined based on a slot number corresponding to a transport block size, TBS.

In other words, the UE may determine M*N TOs to transmit M PUSCH transmissions and the UE would transmit a single TB over N slots in a group. For example, as illustrated in FIG. 4A, assume N=2, and M=2, then UE may determine 4 TOs are grouped to two TO groups to transmit 2 TBs, and each TB is transmitted over 2 slots in each TO group.

In such a case, the number of bits for the indication information may be determined based on a transmission parameter including any of: a number of the at least two TBs; or the number of the at least two TBs and a number of TOs configured to transmit a single TB.

For example, the indication information or the UCI may indicate the unused group(s), and the number of bits is determined based on M. Or alternatively, it may indicate the unused TOs, and the number of bits may be determined based on M*N.

Option-2 (Interaction with for Example Repetition Type A)

In Option-2, all TOs in each of the at least two groups of TOs are configured to transmit different transmission blocks, and wherein the at least two groups of TOs are configured to repeatedly transmit a same set of TBs. The number of the at least two groups of TOs may be determined based on a number of repetitive transmissions of the at least two TBs.

For example, if a repetition type A is configured and if a K is configured, wherein K indication the number of repetitive transmissions of the at least two TBs, and then UE may determine K groups of TOs to repeat M TBs, and the number of TOs in each group is M. In other words, UE determines M*K TOs to transmit M PUSCH transmissions and UE shall repeat M TBs over M*K TOs. For example, as illustrated in FIG. 4B, assume K=2, M=4, then UE determines 8TOs are grouped to two TO groups to transmit 4 TBs' repetition.

In such a case, the number of bits for the indication information may be determined based a transmission parameter, wherein the transmission parameter includes one of: the number of the at least two TBs; or the number of the at least two TBs and the number of repetitive transmissions of the at least two TBs.

For example, if the UCI indicates the unused group(s), and the number of bits is determined based on M. Or alternatively the UCI indicates the unused TOs, and the number of bits is determined based on M*K.

Option-3 (Interaction with for Example Repetition Type A and TBOMS)

In some embodiments, at least two TOs in each of the at least two groups of TOs are configured to transmit a single TB, and at least two other TOs in each of the at least two groups of TOs are configured to transmit another TB, and wherein the at least two groups of TOs are configured to repeatedly transmit a same set of TBs. The number of the at least two groups of TOs may be determined based on a number of repetitive transmissions of the at least two TBs.

For example, if a repetition type A is configured and if K is configured, wherein K indication the number of repetitive transmissions of the at least two TBs, and a parameter N is configured, wherein N represents the slot number corresponding to a transport block (i.e., the slot to calcite the transport block size, TBS), then UE may determine K groups of TOs, and each group has M TOs, and is used to transmit M TBs, and UE may transmit each TBs across N slots. For example, as illustrated in FIG. 4C, assume K=2, M=2, and N=2, then UE determines 8TOs to transmit 2 TBs' repetition, and each TB is transmitted over 2 slots.

In such a case, the number of bits for the indication information may be determined based a transmission parameter, wherein the transmission parameter includes one of: a number of the at least two TBs; or the number of the at least two TBs and a number of TOs configured to transmit a single TB.

For example, if the first UCI indicates the unused TOs in each group, the number of bits may be determined based on M. Or alternatively, it may indicate the unused TOs, and the number of bits may be determined based on M*N.

Reference is made back to FIG. 3A, the terminal device 110 transmits 312 the indication information to a network device 120. Correspondingly, the network device 120 receives the indication information from the terminal device 110, wherein the indication information indicates a usage status of at least one TO or group of TOs among multiple TOs indicated by a configured grant configuration. Then, based on the indication information, the network device 120 determines usage status of the at least one TO or group of TOs among the multiple TOs.

In such a way, the network device may know the unused TOs in the multiple TOs indicated by the CG configuration, and may reschedule resources for e.g. other UEs or other traffic and thus the resource usage for CG may be improved. In addition, some embodiment above may further provide an efficient solution for transmitting multiple different TBs over the configured multiple TOs when multiple CG PUSCH transmission occasions (TOs) are configured.

Moreover, when the Type 2 CG is activated by an activation DCI, a UE configured with Type 2 CG also needs to report an aperiodic channel state information (A-CSI) report (as illustrated in FIG. 2D), a transmission of A-CSI report is to be addressed. Particularly, the inventors notice that currently, when a DCI format 0_1 schedules two PUSCH allocations, the aperiodic CSI report is carried on the second scheduled PUSCH; when a DCI format 0_1 schedules more than two PUSCH allocations, the aperiodic CSI report is carried on the penultimate scheduled PUSCH.

However, for CG type 2, the activation DCI might schedule multiple PUSCH allocation, and some of them would be unused for XR, for example, as illustrated in FIG. 2D, the CSI should be transmitted in the penultimate PUSCH according the current specification. However, the TO is unused and thus may not be used for transmit A-CSI report. To this end, a solution for A-CSI transmission is provided herein and will be described with reference to FIG. 3B.

FIG. 3B illustrates an example signaling chart of an example process 300B according to some embodiments of the present disclosure. For the purpose of discussion, the example 300B will be described with reference to FIG. 1. It is to be understood that the process 300B may be implemented in combination with process 300A or implemented independent of process 300A as a separate aspect of the present disclosure.

As illustrated in FIG. 3B, in the example process 300B, the network device transmits 320 an UL grant in DCI to the terminal device 110 to activate a CG resources previously indicated by a CG configuration and the terminal device 110 receives 322 the uplink grant in a DCI to activate the CG resources.

Then, the terminal device transmits 324 an A-CSI report on a predetermined TO among the multiple TOs in response to an activation indication for the CG configuration, i.e., the received UL grant for activating the CG resources.

In some embodiments, the predetermined TO is a TO not indicated as unused, and wherein the predetermined TO for transmitting the A-CSI report comprises one of: a second used TO when two TOs among the multiple TOs are not indicated as unused; a penultimate used TO when more than two TOs among the multiple TOs are not indicated as unused; a first TO in TOs not indicated as unused; or a last TO in TOs not indicated as unused.

In other words, if two TOs are used among the set of TOs, the A-CSI report is carried on the PUSCH transmit on the second used TOs; if more than two TOs are used among the set of TOs, the A-CSI report is carried on the PUSCH transmission on the penultimate used TOs. Or alternatively, the A-CSI report may be carried on the PUSCH transmit on the first or last used TOs.

In some embodiments, the transmitting the A-CSI report comprises: transmitting the A-CSI report on the predetermined TO without a TB when the predetermined TO is indicated as unused. In other words, if the predefined TO for A-CSI is not used, then the CSI may be transmitted without TB:

In some embodiments, the indication information indicates the predetermined TO for A-CSI as used or does not indicate it as unused. In such a way, it may ensure the predetermined TO may be used to transmit A-CSI. For example, it may maintain the current A-CSI transmission as defined in the specification and meanwhile if the second or penultimate TO be used to transmit the A-CSI is not used to transmit TB, the indication information indicates the second or predetermined TO for A-CSI as used or does not indicate it as unused. Or alternatively, the indication information may indicate all of the multiple TOs configured by the CG configuration as used or does not indicate them as unused to ensure the predetermined TO can be used.

In some embodiments, the transmitting the A-CSI report comprises: transmitting the A-CSI report on a TO which is used for transmitting a TB; or cancelling a transmission of the A-CSI report on a TO when the TO is not used for transmitting a TB. For example, it may maintain the current A-CSI transmission as defined in the specification and meanwhile if the second or penultimate TO be used to transmit the A-CSI is not used, then the A-CSI may be cancelled. In other words, the A-CSI may be transmitted only when the second or penultimate TO is used for a PUSCH transmission.

In some embodiments, a further field may be included in the UCI to indicate whether the TB is carried or not with an A-CSI report. The field may be for example 1 bit.

Correspondingly, the network device 120 receives 326 the A-CSI report on the predetermined TO among the multiple TOs in response to an activation indication for the CG configuration.

With the process as illustrated in FIG. 3B, the UE know how to transmit A-CSI even if some of the multiple TOs which are indicated by a CG configuration are unused, thereby ensuring well-functioning of the terminal device.

Furthermore, when multiple CG configurations are configured for UE, the UE also needs to know how to indicate the unused TO when TOs from multiple CG configuration are overlapped with each other in time domain. Particularly, the inventors notice that if the unused TO indication is designed per CG configuration, which means a UCI could only use to indicate the unused TO for one CG, the unused TO for other CG should indicated by another UCI. Thus, considering that the TOs for different CG would be overlapped in time domain, then there would be a case wherein the gNB can not know whether the TO could be reused for other intention should be decided. As illustrated in FIG. 2E, if a UCI for CG 1 indicates TO #4 is unused, but the gNB could not use the occasion to perform other transmission, because the TO #7 or TO #8 is overlapped (in time domain and/or frequency domain) with TO #4 and the UE may use still these resource TO #7 and/or TO #8 to transmit data. Thus, the gNB needs to further know the UCI for CG 2. This is to say, the UCI for CG type 1 may be useless. To address this issue, a further solution for usage status indication is provided herein and will be described with reference to FIG. 3C.

FIG. 3C illustrates an example signaling chart of an example process 200C according to some embodiments of the present disclosure. For the purpose of discussion, the example 300C will be described with reference to FIG. 1. It is to be understood that the process 300C may be implemented in combination with any of process 300A or 300B or their combination, or alternatively be implemented independent of process 300A as a separate aspect of the present disclosure.

In the example process 300C, the terminal device 110 is configured with at least a first CG configuration and a second CG configuration. As illustrated in FIG. 3C, the terminal device 110 transmits 330 first indication information for the first CG configuration to the network device 120. The first indication information indicates the usage status of a first TO or group of TOs is unused. The first indication information may be carried in a first UCI. Accordingly, at the network side, the network device 120 receives 332 the first indication information.

Then, the terminal device 110 further transmit 334 a second indication information for a second CG configuration to the network device 120. The second indication information indicates usage status of a second TO or group of TOs. The second TO or group of TOs is at least partially overlapping in time domain with the first TO or group of TOs. The second indication information may be carried in a second UCI. Accordingly, at the network side, the network device 120 receives 336 the second indication information.

In some embodiments, the second indication information is configured for indicating the second TO or group of TOs to be used, or not indicating the second TO or group of TOs to be unused, wherein the second indication information is transmitted after the first indication information by a first predetermined time period. The first predetermined time period may be predefined by the specification, standards or the protocol, configured by the network device, or predetermined in any other manners.

In other words, as long as the second UCI is transmitted after the first UCI by a first predetermined time period, the second UCI can only indicate the at least partially overlapping TO or TO groups as used or shall not indicate it as unused, no matter whether the terminal device actually requires to use the at least partially overlapping TO or TO groups or not.

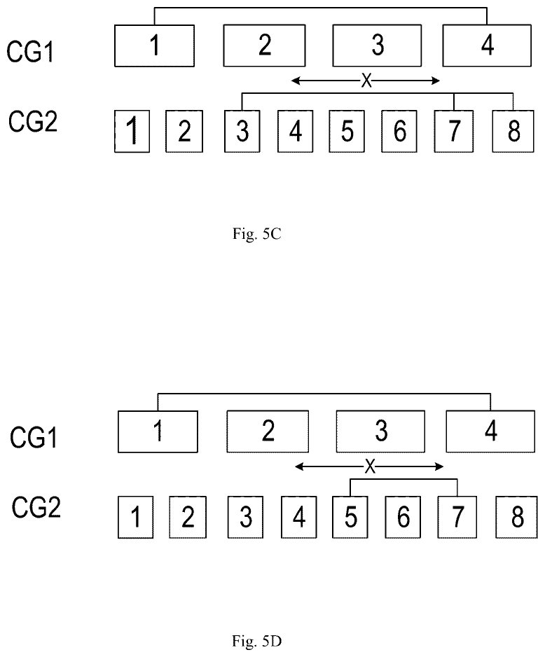

For example, as illustrated in FIG. 5A, the first UCI is transmitted on TO #1 for CG1 and the second UCI is transmitted on TO #3 for CG2. The second indication information is transmitted after the first indication information by a first predetermined time period, and thus, the second UCI may only indicate the TO #7 and TO #8 as used, even if the terminal device actually does not need the two TOs to transmit PUSCH.

In some embodiments, the second indication information is configured for indicating the second TO or group of TOs to be used or unused, wherein the second indication information is transmitted within a same time unit or a same time window with the first predetermined time period as the first indication information. In other words, as long as the second UCI is transmitted within the same time unit (for example the same slot) or the same time window (lasting for example Y slot), the second UCI may indicate the at least partially overlapping TO or TO groups as used or unused, depending on the actual requirements on TOs of CG2.

For example, as illustrated in FIG. 5B, if the second UCI is transmitted in the same time unit as the first UCI, the second UCI may indicate usage status of the TO #7 and TO #8 based on the actual requirements of the terminal device on CG 2.

In some embodiments, the second indication information is configured for indicating the second TO or group of TOs to be used or unused, wherein the second indication information is transmitted before the second TO or group of TOs by a time period not less than a second predetermined time period. The second predetermined time period may be predefined by the specification, standards or the protocol, configured by the network device, or predetermined in any other manners. In other words, if the second UCI is transmitted early enough before the at least partially overlapping TO or TO groups, the second UCI may indicate the at least partially overlapping TO or TO groups as used or unused, depending on the actual requirements on TOs of CG2.

For example, as illustrated in FIG. 5C, the second UCI is transmitted at TO #3 which is before the TO #7 and TO #8 by a time period larger than X time units (e.g., slots), and thus the second UCI may indicate usage status of the TO #7 and TO #8 based on the actual requirements of the terminal device on CG 2.

In some embodiments, the second indication information is configured for indicating the second TO or group of TOs to be unused, wherein the second indication information is transmitted before the second TO or group of TOs by a time period less than the second predetermined time period. In other words, if the second UCI is transmitted not early enough before the at least partially overlapping TO or TO groups, the second UCI may only indicate the at least partially overlapping TO or TO groups as unused, no matter whether the terminal device actually requires to use the at least partially overlapping TO or TO groups or not.

For example, as illustrated in FIG. 5D, the second UCI is transmitted at TO #5 which is before the TO #7 and TO #8 by a time period less than X time units (e.g., slots), and thus the second UCI may only indicate the TO #7 as unused even if the terminal device actually need the TO to transmit PUSCH, it would not be transmitted in this TO.

With the process 300C, the terminal device may know how to transmit the usage status of TOs efficiently, which will facilitate the efficient usage of TOs for CG.

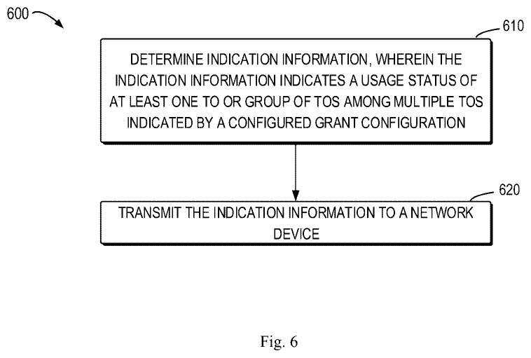

FIG. 6 illustrates a flowchart of a method implemented at a terminal device 110 according to some embodiments of the present disclosure. In some embodiments, the method 600 can be implemented at a communication device, such as the terminal device 110 as shown in FIG. 1. In some other embodiments, the method 600 may be implemented at devices not shown in FIG. 1.

Further, it is to be understood that the method 600 may include additional blocks not shown and/or may omit some blocks as shown, and the scope of the present disclosure is not limited in this regard. For the purpose of discussion, the method 600 will be described from the perspective of the terminal device 110 with reference to FIG. 1.

At block 610, the terminal device 110 determines indication information, wherein the indication information indicates a usage status of at least one transmission occasion (TO) or group of TOs among multiple TOs indicated by a configured grant configuration. At block 620, the terminal device 110 transmits the indication information to a network device 120.

In some embodiments, at least two groups of TOs of the multiple TOs may be available for transmitting at least two TBs.

In some embodiments, a number of the at least two groups of TOs may be determined based on a number of the at least two TBs.

In some embodiments, all TOs in each of the at least two groups of TOs may be configured to transmit a single TB, and the at least two groups of TOs are configured to transmit different TBs.

In some embodiments, a number of the at least two groups of TOs may be determined based on a number of repetitive transmissions of the at least two TBs.

In some embodiments, all TOs in each of the at least two groups of TOs may be configured to transmit different transmission blocks, and the at least two groups of TOs are configured to repeatedly transmit a same set of TBs.

In some embodiments, at least two TOs in each of the at least two groups of TOs may be configured to transmit a single TB, and at least two other TOs in each of the at least two groups of TOs may be configured to transmit another TB, and the at least two groups of TOs may be configured to repeatedly transmit a same set of TBs.

In some embodiments, a number of TOs configured to transmit a single TB may be determined based on a slot number corresponding to a transport block size, TBS.

In some embodiments, a number of bits for the indication information may be determined based a transmission parameter, wherein the transmission parameter includes one of: a number of the at least two TBs; the number of the at least two TBs and a number of TOs configured to transmit a single TB; or the number of the at least two TBs and a number of repetitive transmissions of the at least two TBs.

In some embodiments, the terminal device 110 may be configured with at least a first CG configuration and a second CG configuration, and wherein the transmitting the indication information further comprises: transmitting first indication information for the first CG configuration to the network device 120, and transmitting second indication information for a second CG configuration to the network device 120. The first indication information indicates the usage status of a first TO or group of TOs is unused. The second indication information indicates usage status of a second TO or group of TOs at least partially overlapping in time domain with the first TO or group of TOs.

In some embodiments, the second indication information may be configured for one of:
indicating the second TO or group of TOs to be used, or not indicating the second TO or group of TOs to be unused, wherein the second indication information is transmitted after the first indication information by a first predetermined time period;
indicating the second TO or group of TOs to be used or unused, wherein the second indication information is transmitted within a same time unit or a same time window with the first predetermined time period as the first indication information;
indicating the second TO or group of TOs to be used or unused, wherein the second indication information is transmitted before the second TO or group of TOs by a time period not less than a second predetermined time period, or indicating the second TO or group of TOs to be unused, wherein the second indication information is transmitted before the second TO or group of TOs by a time period less than the second predetermined time period.

In some embodiments, the terminal device 110 may be further configured to: transmit an aperiodic channel state information, A-CSI, report on a predetermined TO among the multiple TOs in response to an activation indication for the CG configuration.

In some embodiments, the predetermined TO may be a TO not indicated as unused, and the predetermined TO for transmitting the A-CSI report comprises one of: a second used TO when two TOs among the multiple TOs are not indicated as unused; a penultimate used TO when more than two TOs among the multiple TOs are not indicated as unused; a first TO in TOs not indicated as unused; or a last TO in TOs not indicated as unused.

In some embodiments, the transmitting the A-CSI report may comprise: transmitting the A-CSI report on the predetermined TO without a TB when the predetermined TO is indicated as unused.

In some embodiments, the indication information may indicate the predetermined TO as used or does not indicate it as unused; or the indication information indicates the multiple TOs configured by the CG configuration as used or does not indicate them as unused.

In some embodiments, the transmitting the A-CSI report may comprise: transmitting the A-CSI report on a TO which is used for transmitting a TB; or cancelling a transmission of the A-CSI report on a TO when the TO is not used for transmitting a TB.

In some embodiments, the indication information may comprise a field indicative whether an A-CSI report is transmitted.

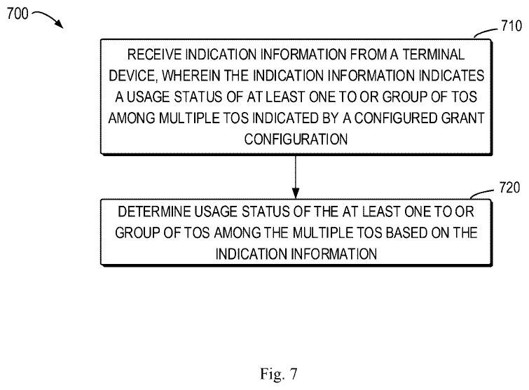

FIG. 7 illustrates a flowchart of a method implemented at a network device according to some embodiments of the present disclosure. In some embodiments, the method 700 can be implemented at a communication device, such as the network device 120 as shown in FIG. 1. In some other embodiments, the method 700 may be implemented at devices not shown in FIG. 1. Further, it is to be understood that the method 700 may include additional blocks not shown and/or may omit some blocks as shown, and the scope of the present disclosure is not limited in this regard. For the purpose of discussion, the method 700 will be described from the perspective of the network device 120 with reference to FIG. 1.

At block 710, the network device 120 receives indication information from a terminal device 110, wherein the indication information indicates a usage status of at least one transmission occasion (TO) or group of TOs among multiple TOs indicated by a configured grant configuration. At block 720, the network device 120 determines usage status of the at least one TO or group of TOs among the multiple TOs based on the indication information.

In some embodiments, at least two groups of TOs of the multiple TOs may be available for at least two TBs.

In some embodiments, a number of the at least two groups of TOs may be determined based on a number of the at least two TBs.

In some embodiments, all TOs in each of the at least two groups of TOs may be configured to receive a single TB, and the at least two groups of TOs are configured to receive different TBs.

In some embodiments, a number of the at least two groups of TOs may be determined based on a number of repetitive transmissions of the at least two TBs.

In some embodiments, all TOs in each of the at least two groups of TOs may be configured to receive different transmission blocks, and the at least two groups of TOs may be configured to receive repeatedly transmitted same set of TBs.

In some embodiments, at least two TOs in each of the at least two groups of TOs may be configured to transmit a single TB, and at least two other TOs in each of the at least two groups of TOs may be configured to transmit another TB, and the at least two groups of TOs may be configured to receive repeatedly transmitted same set of TBs.

In some embodiments, a number of TOs configured to receive a single TB may be determined based on a slot number corresponding to a transport block size, TBS.

In some embodiments, a number of bits for the indication information may be determined based a transmission parameter, wherein the transmission parameter includes one of: a number of the at least two TBs; the number of the at least two TBs and a number of TOs configured to transmit a one TB; or the number of the at least two TBs and a number of repetitive transmissions of the at least two TBs.

In some embodiments, the network device 120 may configure the terminal device 110 with at least a first CG configuration and a second CG configuration, and wherein the receiving the indication information may further comprise: receiving first indication information for the first CG configuration from the terminal device 110; and receiving second indication information for a second CG configuration from the terminal device 110. The first indication information indicates the usage status of a first TO or group of TOs is unused. The second indication information indicates usage status of a second TO or group of TOs at least partially overlapping in time domain with the first TO or group of TOs.

In some embodiments, the second indication information may be configured for one of:
indicating the second TO or group of TOs to be used, or not indicating the second TO or group of TOs to be unused, wherein the second indication information is received after the first indication information by a first predetermined time period;
indicating the second TO or group of TOs to be used or unused, wherein the second indication information is received within a same time unit or a same time window with the first predetermined time period as the first indication information;
indicating the second TO or group of TOs to be used or unused, wherein the second indication information is received before the second TO or group of TOs by a time period not less than a second predetermined time period, or
indicating the second TO or group of TOs to be unused, wherein the second indication information is received before the second TO or group of TOs by a time period less than the second predetermined time period.

In some embodiments, the network device 120 may be further configured to: receive an aperiodic channel state information, A-CSI, report on a predetermined TO among the multiple TOs in response to an activation indication for the CG configuration.

In some embodiments, the predetermined TO may be a TO not indicated as unused, and the predetermined TO for transmitting the A-CSI report comprises one of: a second used TO when two TOs among the multiple TOs are not indicated as unused; a penultimate used TO when more than two TOs among the multiple TOs are not indicated as unused; a first TO in TOs not indicated as unused; or a last TO in TOs not indicated as unused.

In some embodiments, the receiving the A-CSI report may comprises: receiving the A-CSI report on the predetermined TO without a TB when the predetermined TO is indicated as unused.

In some embodiments, the indication information may indicate the predetermined TO as used or does not indicate it as unused; or the indication information indicates the multiple TOs configured by the CG configuration as used or does not indicate them as unused.

In some embodiments, the receiving the A-CSI report may comprise: receiving the A-CSI report on a TO which is used for transmitting a TB; or cancelling a reception of the A-CSI report on a TO when the TO is not used for transmitting a TB.

In some embodiments, the indication information may comprise a field indicative whether an A-CSI report is transmitted.

### Example Apparatus

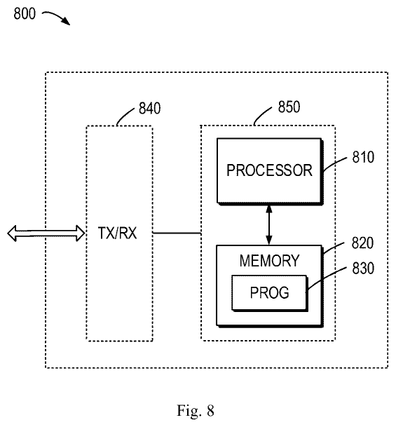

FIG. 8 illustrates a simplified block diagram of a device 800 that is suitable for implementing embodiments of the present disclosure. The device 800 can be considered as a further example implementation of the terminal device 110, and the network device 120 as shown in FIG. 1. Accordingly, the device 800 can be implemented at or as at least a part of the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 830 is assumed to include program instructions that, when executed by the associated processor 810, enable the device 800 to operate in accordance with the embodiments of the present disclosure, as discussed herein with reference to FIGS. 1-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, an apparatus capable of performing the method 600 (for example, the terminal device 110) may comprise means for performing the respective steps of the method 600. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 600.

In some embodiments, an apparatus capable of performing the method 700 (for example, the network device 120) may comprise means for performing the respective steps of the method 700. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 700.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device for wireless communication, comprising:
at least one memory; and
at least one processor coupled with the at least one memory and operable to cause the terminal device to:
determine indication information, wherein the indication information indicates a usage status of at least one transmission occasion (TO) or group of TOs among multiple TOs indicated by a configured grant (CG) configuration; and
transmit the indication information to a network device.

2. The terminal device of claim 1, wherein at least two groups of TOs of the multiple TOs are available for transmitting at least two transmission blocks (TBs).

3. The terminal device of claim 2, wherein a number of the at least two groups of TOs is determined based on a number of the at least two TBs.

4. The terminal device of claim 2, wherein all TOs in each of the at least two groups of TOs are configured to transmit a single TB, and the at least two groups of TOs are configured to transmit different TBs.

5. The terminal device of claim 2, wherein a number of the at least two groups of TOs is determined based on a number of repetitive transmissions of the at least two TBs.

6. The terminal device of claim 5, wherein all TOs in each of the at least two groups of TOs are configured to transmit different transmission blocks, and wherein the at least two groups of TOs are configured to repeatedly transmit a same set of TBs.

7. The terminal device of claim 5, wherein a number of bits for the indication information is determined based a transmission parameter, wherein the transmission parameter includes one of:
a number of the at least two TBs;
the number of the at least two TBs and a number of TOs configured to transmit a single TB; or
the number of the at least two TBs and a number of repetitive transmissions of the at least two TBs.

8. The terminal device of claim 1, wherein the terminal device is configured with at least a first CG configuration and a second CG configuration, and wherein the transmitting the indication information further comprises:
transmitting first indication information for the first CG configuration to the network device; and
transmitting second indication information for the second CG configuration to the network device,
wherein the first indication information indicates the usage status of a first TO or group of TOs is unused, and wherein the second indication information indicates usage status of a second TO or group of TOs at least partially overlapping in time domain with the first TO or group of TOs.

9. The terminal device of claim 8, wherein the second indication information is configured for one of:
indicating the second TO or group of TOs to be unused, or not indicating the second TO or group of TOs to be used, wherein the second indication information is transmitted after the first indication information by a first predetermined time period;
indicating the second TO or group of TOs to be used or unused, wherein the second indication information is transmitted within a same time unit or a same time window with the first predetermined time period as the first indication information;
indicating the second TO or group of TOs to be used or unused, wherein the second indication information is transmitted before the second TO or group of TOs by a time period not less than a second predetermined time period; or
indicating the second TO or group of TOs to be unused, wherein the second indication information is transmitted before the second TO or group of TOs by a time period less than the second predetermined time period.

10. The terminal device of claim 1, wherein the at least one processor is operable to cause the terminal device to:
transmit an aperiodic channel state information (A-CSI) report on a predetermined TO among the multiple TOs, in response to an activation indication for the CG configuration.

11. The terminal device of claim 10, wherein the predetermined TO for transmitting the A-CSI report comprises one of:
a second used TO when two TOs among the multiple TOs are not indicated as unused;
a penultimate used TO when more than two TOs among the multiple TOs are not indicated as unused;
a first TO in TOs not indicated as unused; or
a last TO in TOs not indicated as unused.

12. The terminal device of claim 10, wherein the indication information indicates the predetermined TO as used or does not indicate the predetermined TO as unused; or
wherein the indication information indicates the multiple TOs configured by the CG configuration as used or does not indicate the multiple TOs configured by the CG configuration as unused.

13. A network device for wireless communication, comprising:
at least one memory; and
at least one processor coupled with the at least one memory and operable to cause the network device to:
receive indication information from a terminal device, wherein the indication information indicates a usage status of at least one transmission occasion (TO) or group of TOs among multiple TOs indicated by a configured grant configuration; and
determine usage status of the at least one TO or group of TOs among the multiple TOs based on the indication information.

14. A method performed by a terminal device, the method comprising:
determining indication information, wherein the indication information indicates a usage status of at least one transmission occasion (TO) or group of TOs among multiple TOs indicated by a configured grant configuration; and
transmitting the indication information to a network device.

15. The method of claim 14, wherein at least two groups of TOs of the multiple TOs are available for transmitting at least two transmission blocks (TBs).

16. The method of claim 15, wherein a number of the at least two groups of TOs is determined based on a number of the at least two TBs.

17. The method of claim 15, wherein all TOs in each of the at least two groups of TOs are configured to transmit a single TB, and the at least two groups of TOs are configured to transmit different TBs.

18. The method of claim 15, wherein a number of the at least two groups of TOs is determined based on a number of repetitive transmissions of the at least two TBs.

19. The method of claim 18, wherein all TOs in each of the at least two groups of TOs are configured to transmit different transmission blocks, and wherein the at least two groups of TOs are configured to repeatedly transmit a same set of TBs.

20. A method performed by a network device, the method comprising:
receiving indication information from a terminal device, wherein the indication 14 information indicates a usage status of at least one transmission occasion (TO) or group of TOs among multiple TOs indicated by a configured grant configuration; and
determining usage status of the at least one TO or group of TOs among the multiple TOs based on the indication information.
